(19) United States
(12) Patent Application Publication
(10) Pub. No.: US 2009/0293670 A1
(43) Pub. Date: Dec. 3, 2009

(54) Electric Starting Device for an Internal Combustion Engine

(75) Inventors: Sebastian Sekira, Seeham (AT); Andreas Bilek, Buchkirchen (AT)

Correspondence Address: LAW OFFICE OF ROD D. BAKER, 707 STATE HIGHWAY 333, SUITE B, TIJERAS, NM, 87059-7382, US

(73) Assignee: KTM Sportmotorcycle AG, Mattighofen (AT)

(21) Appl. No.: 11/989,724

(22) PCT Filed: Jul. 28, 2006
(86) PCT No.: PCT/EP2006/007506

§ 371 Date: Jul. 23, 2009

(30) Foreign Application Priority Data
Aug. 1, 2005 (DE) 10 2005 036 087.4

(51) Int. Cl. F02N 15/04

(52) U.S. Cl. 74/7 E

(57) ABSTRACT

The invention proposes an electric starting device for an internal combustion engine, having a starter motor (2) which can, by means of an angular gearing (14) and with the interposition of a pre-engaged drive (10), be placed in engagement with a toothing (12) on an ignition rotor (13) in order to act on a crankshaft of the internal combustion engine (15), wherein the motor shaft of the starter motor (2) is arranged substantially perpendicularly to the crankshaft axis, the angular gearing (14) has a crown gear (3) and a cylindrical gear (5) which are arranged in a rotationally fixed manner on an intermediate shaft (4), and the cylindrical gear (5) meshes with a cylindrical gear (8) of the pre-engaged drive (10).

The present invention relates to an electric starting device for an internal combustion engine as it reads from the preamble of claim 1.

Internal combustion engines comprising electric starting devices are already known in a wealth of different versions. When the internal combustion engine or engine powering a two-wheeler, particularly a motorcycle, is to be fitted with an electric starting device, the starter motor is normally arranged on the engine so that the longitudinal centerline of the motor shaft of the starter motor is oriented parallel to the longitudinal centerline of the crankshaft of the engine. In this arrangement the starter motor may be located ahead of the crankshaft when viewed in the forwards direction of the motorcycle, or it may also be located aft of the crankshaft when needing to be sited safely away from stone impact thrown up by, for example, the front wheel of the motorcycle.

With a known starting device, the electric starter motor rotates the crankshaft via an over-running clutch provided at the primary drive end or the ignition end of the crankcase. Via gears between the starter motor and the over-running clutch, the high rotary speed of the starter motor is stepped down to the slower rotary speed as required for starting rotation of the crankshaft. In this arrangement the over-running clutch usually runs in a oil bath, this being the reason why such an arrangement is normally to be found on four-stroke engines.

Electric starting devices for internal combustion engines are also known, however, in which the electric starter motor can be brought into engagement with a toothing to power the crankshaft of the internal combustion engine via an angular gearing with a pre-engaged drive interposed. In such an arrangement, because of the angular gearing, the shaft of the starter motor can also be located in a situation in a departure from being parallel to the longitudinal centerline of the crankshaft, for example, roughly at right angles thereto.

In such arrangements the shaft of the electric starter motor usually features a worm spindle meshing with a worm gear capable of causing the crankshaft of the internal combustion engine to rotate. In this arrangement the worm spindle needs to be precisely aligned with the worm gear both axially and angularly. One such arrangement is known for example from DE 197 12 968 A1 describing a reciprocating piston internal combustion engine incorporating a worm gear starting device connecting the crankshaft of the internal combustion engine via an over-running clutch and comprising, connected to the electric starter motor, a worm spindle meshing with the worm gear. Such a worm gear has the additional drawback of low efficiency, and requires a large and thus heavy starter motor. In addition, the self-locking of the worm gear may be a problem, namely then, when the engine fails to start, it instead kicking back as may be the case with single-cylinder engines having a large swept volume.

Known from GB 782,140 A1 is an electric starting device for a motor scooter in which a worm spindle meshes with a worm gear driving a shaft engaging via a spur toothing a further shaft, at the output end of which an angular gearing is arranged which in turn causes rotation of the crankshaft of the motor scooter engine. In this arrangement there is thus provided a worm gear, on the one hand, and, on the other, an angular gearing in the form of a bevel gear toothing so that in addition to the complications in needing to ensure that the worm gear is correctly located, implementing this known electric starting device involves a complicated and costly design.

Known in conclusion from German patent DE 1 912 228 is an electric starting device incorporating an angular gearing in which the electric starter motor can be brought into engagement via an angular gearing and an interposed pre-engaged drive with the crankshaft of the internal combustion engine so that the engine can be started electrically. In this known electric starting device, the toothing for an output pinion of the pre-engaged drive is provided on an outboard flywheel of the crankshaft, the internal combustion engine in this case being a lawnmower engine. In this arrangement the shaft of the electric starter motor runs at right angles to the longitudinal centerline of the crankshaft, the output shaft of the electric starter motor acting directly on the shaft of the pre-engaged drive. Directly driving the pre-engaged drive via an electric starter motor necessitates a large diameter toothing, provided in this case on the flywheel which in turn results in a high rotational moment of inertia, undesirable with off-road competition motorcycles.

One criterion salient to the application of an internal combustion engine for powering an off-road competition motorcycle is minimizing the overall weight of the motorcycle, and thus the overall weight of the internal combustion engine. This is why the engines of off-road competition motorcycles usually have no electric starting device because this adds to the overall weight of the vehicle significantly. Instead, these engines are usually started by a kick starter which makes for further stress on the biker of an off-road competition motorcycle who, when his concentration is exhausted, has killed the engine and has to kick start, perhaps repeatedly. On top of this, competition time is lost with the bike immobile.

It is on the basis of the above considerations that the present invention has the object of providing an electric starting device for an internal combustion engine which is both compact and lightweight and which, in addition, can be retrofitted to the engine, be this in production or as an add-on component in thus enabling a motorcycle having such an internal combustion engine to be retrofitted with an electric starting device. It is also an object of the invention to provide a two-stroke internal combustion engine with such an electric starting device and a motorcycle featuring such a two-stroke internal combustion engine.

The invention achieves this object by an electric starting device having the features as set forth in claim 1, advantageous aspects thereof reading from the further claims. The invention also provides for a two-stroke internal combustion engine as set forth in claim 9 as well as a motorcycle as set forth in claim 10.

The invention now provides for an electric starting device for an internal combustion engine including a starter motor which can be brought into engagement via an angular gearing and an interposed pre-engaged drive with a toothing on an ignition rotor for powering a crankshaft of the internal combustion engine, and in that the shaft of the starter motor is arranged substantially at right angles to the longitudinal centerline of the crankshaft, the angular gearing comprising a crown wheel and a spur gear arranged non-rotatable on an intermediate shaft and the spur gear meshing with a spur gear of the pre-engaged drive.

The electric starter motor and respectively its shaft thus do not directly engage the pre-engaged drive, but by the interposed angular gearing comprising a crown wheel and a spur gear which, on the one hand, now make it possible to fit the starter motor near to the engine, i.e., snug to a cylinder of the engine and/or frame component of the motorcycle. In addition to this, this facilitates retrofitting the electric starting device, since the crown wheel makes for axial freedom of the spur gear of the electric starter motor in thus simplifying retrofitting, since the demands on accuracy in axially orienting the shaft of the electric starter motor relative to the crown wheel are lower than the demands on accuracy in fitting an angular gearing featuring a bevel gear. Also, a lightweight electric starting device can now be implemented in satisfying the low weight requirement since because of the crown wheel, even with deformation inherent to operation of the electric starting device, there is hardly any change in the contact pattern between the spur gear of the motor shaft and the crown wheel with changes in load. The crown wheel can be produced, for example, by means of cold pressing and thus cost-effectively unlike the toothing of a bevel gear with greater freedom as to tolerances on production and assembly.

The starter motor is arranged so that a longitudinal centerline of the motor shaft is aligned with the toothing of the spur gear of the angular gearing such that the longitudinal centerline and the toothing of the spur gear are now located on one side of a longitudinal centerplane of the crown wheel, making for a slim configuration of the electric starting device in enabling the starter motor to now be fitted snug to the cylinder and frame and thus remote from being damaged by stone impact thrown up, for example, by the front wheel of the motorcycle.

In accordance with the invention it is provided for that the angular gearing and the pre-engaged drive are disposed between a crankcase of the engine and a cover concealing the ignition rotor as may be defined on the crankcase. This arrangement now makes it possible to fit the angular gearing and pre-engaged drive beneath the cover concealing the ignition rotor, also termed ignition cover, where it is remote from the zone of the aforementioned stone impact as thrown up by the front wheel. In addition, this aspect has the advantage that no modifications need to be made to the design of the internal combustion engine. In other words, this is compatible with the straight kick-started version of the engine, on the one hand, and with the engine incorporating an electric starting device, on the other, as well as when the engine combines both the electric starting device and a kick starter.

The starter motor in this arrangement is located remotely from the ignition cover and can be defined by means of a support on a frame component of the two-wheeler such as, for example, an off-road competition motorcycle. The frame component may be, for example, a frame bracing manufactured with a threaded lug on the latter for screw-mounting the electric starter motor by means of the support. The support may be a support comprising just one supporting member or also a support comprising two supporting members so that, for example, the electric starter motor can be defined on the frame bracing by means of a vee-type support.

Such a support may also be provided on the starter motor itself, for example, integrated in a component of the starter motor casing. Via this support the starter motor can then be defined on the engine itself. For this purpose, the starter motor may be defined, for example, on the ignition cover by means of stud bolts. In turn, the ignition cover may be defined on the crankcase of the engine so that the starter motor is thereby secured to the engine.

In this arrangement, locating the starter motor on the frame component or on the engine is selected such that it is arranged—as viewed in the forwards direction of the two-wheeler—aft of a combustion gas conducting member and both beneath and within an outer surface of a fuel tank of the two-wheeler.

In other words, the electric starter motor is now defined so snugly located at the cylinder on the frame component or on the engine that—again as viewed in the forwards direction of the two-wheeler—it is sited aft of the exhaust manifold, which on a two-stroke engine may be what is called a two-stroke bulb, where it is safe from stone impact as thrown up by the front wheel whilst also being located beneath and within an outer surface of the fuel tank of the motorcycle, so that the electric starter motor does not come into contact with the ground even when the off-road competition motorcycle is toppled.

The location of the pre-engaged drive is selected so that a longitudinal centerline of the shaft carrying a pinion of the pre-engaged drive rides practically parallel to the longitudinal centerline of the crankshaft. In conclusion, the invention also provides for a two-stroke internal combustion engine featuring an electric starting device as described above, and a vehicle having a frame and at least one front wheel as well as at least one rear wheel featuring the aforementioned two-stroke internal combustion engine. In this arrangement the two-stroke internal combustion engine configured as such for off-road competition motorcycles may also be fitted—if desired—to a four-wheel vehicle such as, for example, an all-terrain vehicle (ATV).

As compared to a starting device sited—for example as viewed in the forwards direction—aft of the cylinder of the internal combustion engine the starting device in accordance with the invention excels by its numerous advantages. Now, the location at which the driving torque for starting the internal combustion engine is created is closer to the location at which this driving torque is introduced into the crankshaft of the engine. When, namely, the electric starter motor—as is the case with known starting devices—aft of the cylinder of the engine (as viewed in the forwards direction) the output torque of the electric starter motor needs to be transmitted by means of a cascade gear train, a chain, or a ribbed belt, or the like to the crankshaft. In addition to adding to costs of production, this also complicates maintenance as needed for the aforementioned chain and/or ribbed belt drive. Such an arrangement also means a collision with the fuel tank of the vehicle since it would result in a further reduction in the capacity of such a fuel tank, already reduced to save weight. Because of the longer path for transmitting the torque between the electric starter motor and the crankshaft when the starter motor is mounted aft of the cylinder, a complicated and complex engine case is needed which again is contradictory to the intention of retrofitting an electric starting device to an existing engine concept. On top of this, making use of such an engine casing mounting an electric starter motor aft of the engine cylinder would only be possible in conjunction with the electric starting device, but not as an engine casing having just a kick starter.

All of the drawbacks as recited above are now eliminated by the electric starting device in accordance with the invention. The electric starting device in accordance with the invention can also be retrofitted to an internal combustion engine and the electric starter motor is located safely away from the zone of stone impact thrown up by the motorcycle and away from the topple-hazard zone of the motorcycle. In addition, the angular gearing and pre-engaged drive can now be located beneath the ignition cover, i.e., in a space free of the oil bath, without adding to the overall width of the engine featuring the electric starting device in accordance with the invention.

The starter motor is now sited in the direct vicinity of the ignition rotor splined to the crankshaft so that the output torque of the starter motor no longer needs to be transmitted over a long path into the toothing of the ignition rotor so that by omitting this long path also the overall weight of the electric starting device in accordance with the invention is reduced. The electric starting device can be fitted both in manufacture and retrofitted as an add-on solution on internal combustion engines furnished without the electric starting device, in thus making it possible to retrofit the off-road competition motorcycle with the electric starting device in accordance with the invention.

The invention will now be detained with reference to the drawing in which:

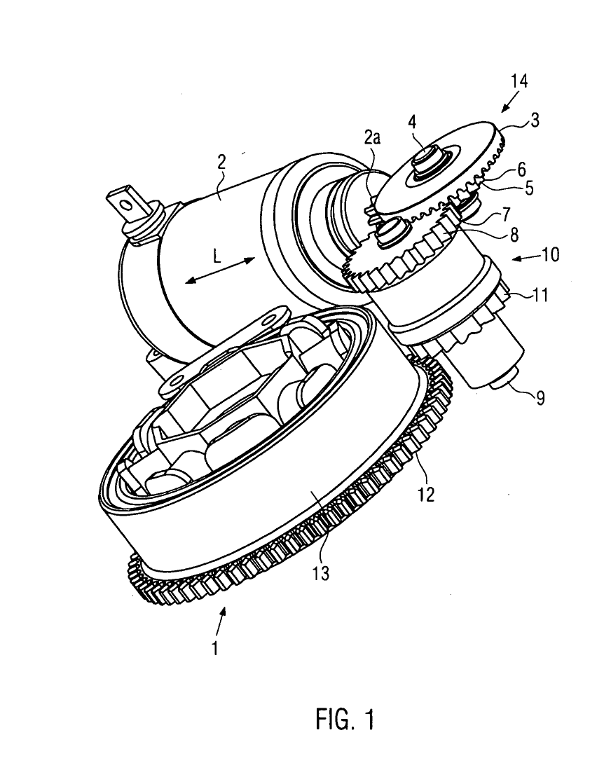

FIG. 1 is a view in perspective of an embodiment of an electric starting device in accordance with the invention;

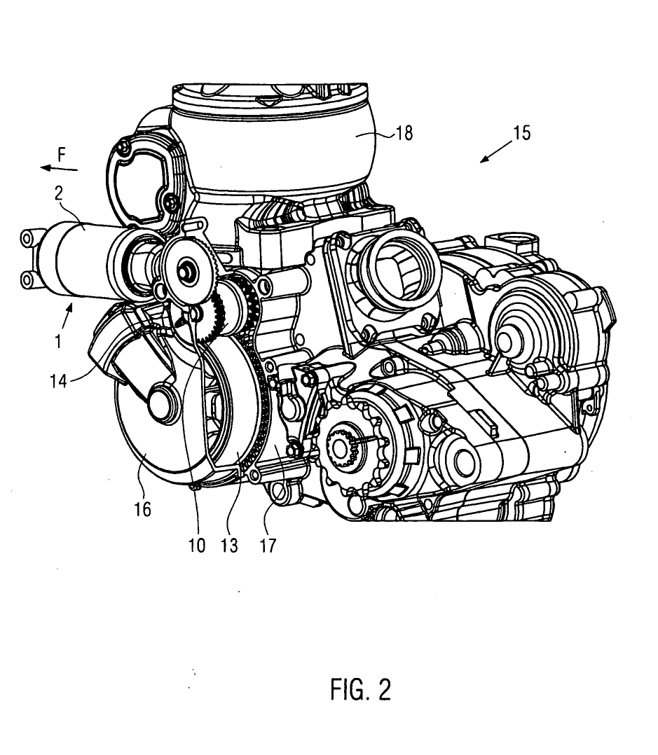

FIG. 2 is a partly sectioned view in perspective of an internal combustion engine mounting an electric starting device;

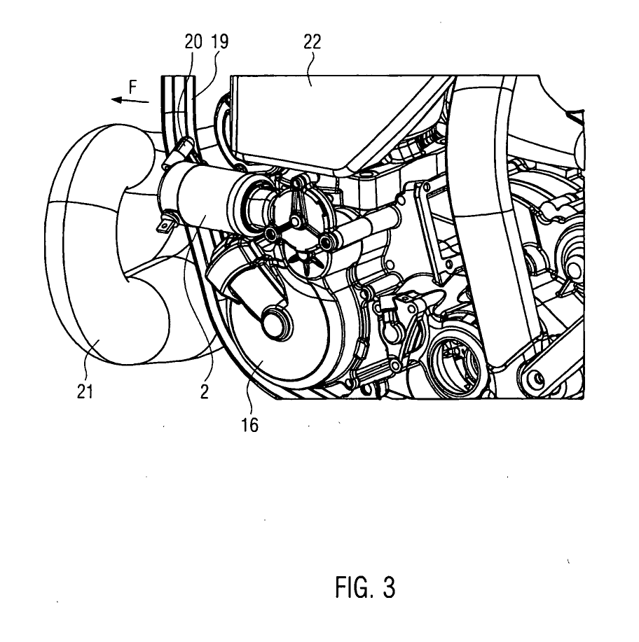

FIG. 3 is a view in perspective of an internal combustion engine including an electric starting device incorporated in a motorcycle frame;

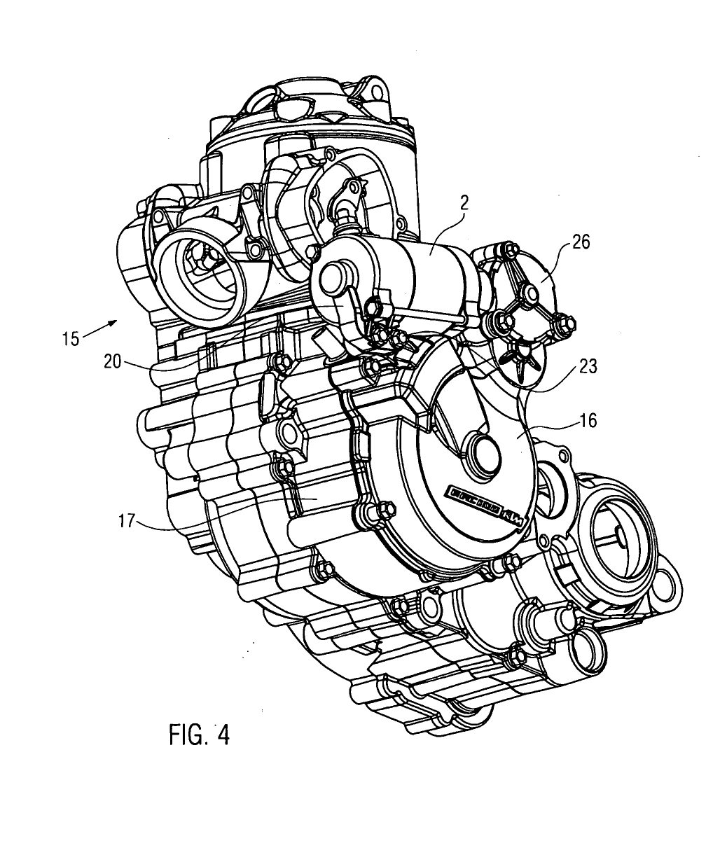

FIG. 4 is a view in perspective of an internal combustion engine including a second embodiment of the electric starting device; and

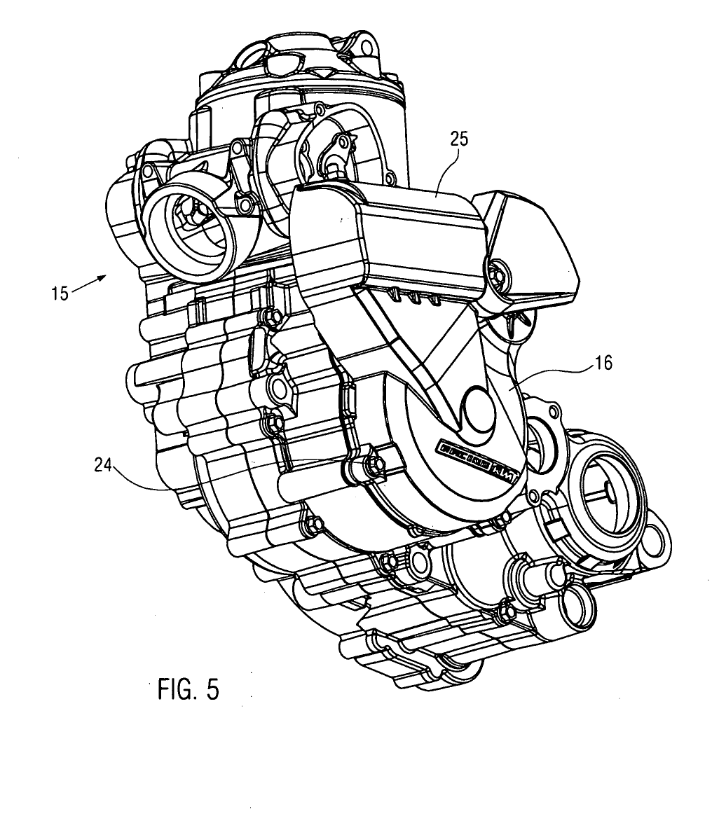

FIG. 5 is a view similar to that as shown in FIG. 4 showing a cover on the electric starting device.

Referring now to FIG. 1 of the drawing, there is illustrated a view in perspective of an embodiment of an electric starting device 1 in accordance with the invention.

As is immediately evident, the electric starting device 1 comprises a starter motor 2 having a spur gear 2a arranged non-rotatable on the shaft (not shown) of the starter motor 2 which meshes with a crown wheel 3. The longitudinal centerline of the motor shaft in this arrangement is oriented along the direction as indicated by the double arrow L.

The crown wheel 3 in this arrangement is arranged axially non-rotatable on an intermediate shaft 4 which also comprises a spur gear 5 likewise arranged axially non-rotatable thereon with a spur gear toothing 6.

The spur gear toothing 6 meshes with a spur gear toothing 7 of a spur gear 8 arranged axially non-rotatable on a shaft 9 of a pre-engaged drive 10. In addition, the pre-engaged drive 10 comprises a riding pinion 11 for which can be brought into engagement with a toothing 12 provided on an ignition rotor 13.

As evident from FIG. 1, the location of the starter motor 2 relative to the crown wheel 3 of the angular gearing 14 is selected such that the longitudinal centerline L of the shaft of the starter motor 2 is oriented in the direction of the spur gear toothing 6 of the spur gear such that both the spur gear 5 and the spur gear 2a are sited in common on one side of a longitudinal centerplane passing through the crown wheel 3 and intersecting the intermediate shaft 4 at right angles. It is this arrangement that achieves a compact, space-saving configuration of the electric starting device 1 in accordance with the invention.

Referring now to FIG. 2 there is illustrated in a partly sectioned view in perspective a single-cylinder two-stroke engine 15 and its transmission mounting an electric starting device 1 in accordance with the invention.

The engine 15 is a high performance single cylinder two-stroke engine as provided in an arrangement, for example, on a competition enduro motorcycle. As is immediately evident, the ignition rotor 13 is arranged on the left as viewed in the forwards direction F of a crankshaft (not shown) of the engine 15 and located beneath an ignition cover 16 bolted to the crankcase 17.

The ignition cover 16 also conceals the pre-engaged drive 10 and the angular gearing 14. As is directly apparent from FIG. 2 and particularly FIG. 3, the arrangement of the starter motor 2 is selected so that it is sited, on the one hand, snug to the cylinder 18 and, on the other, to the frame bracing 19 of the off-road competition motorcycle (not shown). In this arrangement, the starter motor 2 can be defined by a support 20 on the frame bracing 19 or also by means of the support 20 as may be bolted to the crankcase 17 or lug of the crankcase 17, in which case no corresponding link needs to be provided at the frame bracing 19. One such embodiment is shown in FIG. 4. In this case, the starter motor 2 comprises a support 20 integrated in a casing component of the starter motor 2. Via this support 20 the starter motor 2 may be defined on the engine 15 itself, i.e. via the ignition cover 16. For this purpose, the ignition cover 16 features two tappings into which two studs 23 are screwed for defining the starter motor 2 at the engine 15, so that the ignition cover 16 can be defined on the crankcase 17 of the engine 15 by studs 24. In other words, no corresponding link is provided at the frame bracing 19.

Referring now to FIG. 3 of the drawing, there is illustrated how the starter motor 2, as viewed in the forwards direction F of the motorcycle, is sited aft of an exhaust means 21 (two-stroke bulb) to block thrown up stone impact by the two-stroke bulb 21 from the starter motor 2. In addition, the starter motor 2 is also sited beneath and within an outer surface 22 of the a fuel tank (not shown) of the motorcycle, so that should the motorcycle topple to the left, the starter motor 2 does not come into contact with the ground. The pre-engaged drive 10 and the angular gearing 14 are mounted in dry-running, hard-wearing bushes in the crankcase 17 and in the ignition cover 16 as well as in a cover 26 concealing the crown wheel 3, in thus achieving a more compact mounting arrangement than, for example, with roller bearings.

Referring now to FIG. 5 there is illustrated furthermore how the starter motor 2 and the crown wheel 3 arranged beneath the cover 26 are concealed by means of a cover 25 as can be secured to the engine 15 by studs 24, which also serve to define the ignition cover 16 on the crankcase 17 of the engine 15.

The electric starting device provided for in accordance with the invention is accordingly characterized in that due to its compact, lightweight, space-saving configuration it can be fitted to an off-road competition motorcycle without negatively influencing the overall weight and thus the handling dynamics of the motorcycle.

Because of its compact configuration, the electric starting device can also be fitted to the internal combustion engine of the off-road competition motorcycle so that it is safely protected from damage by e.g. stone impact, toppling, wetting, etc.

The electric starting device in accordance with the invention can be integrated in existing engine concepts without requiring them to be modified. The starter motor can be fitted to the motorcycle so that no modification whatsoever is needed to the motorcycle. All that is needed are the attachment items such as, for example, vehicle battery and a starter button as required for electric starter operation, without having to remove the engine from the frame or dismantling the engine. On the other hand, an engine concept originally designed for kick starting operation can be modified by a slight modification to one half of the crankcase in manufacture in the region of the ignition cover for retrofitting starting device operation. Since the electric starting device does not add to the width of the motorcycle when fitted and is configured lightweight and compact, there is no sacrifice involved in the competition capacity of the motorcycle.

Because total torque transmission from starter motor to crankshaft of the engine can be concealed by the ignition cover it is safely protected from external damage. In addition, to this, the electric starting device in accordance with the invention requires no oil bath and can thus be integrated in the dry ignition space. The pre-engaged drive provided in accordance with the invention permits total release of the starting device from the engine once the engine has started, unlike a known achievement in which with an over-running clutch running in an oil bath which also produces friction when freewheeling. Due to the large toothing of the ignition rotor and the intermediate shaft provided in accordance with the invention the required stepdown in starter motor speed for starting the crankshaft is achieved without any intermediate gear ratio changing gears being needed. No modifications to the engine are needed for including the electric starting device in accordance with the invention. It can thus be provided both for straight electric starting and for combination electric and kick starting or also just for operation with a kick starter in which case the electric starting device can also be retrofitted.

As regards any features not having been detained above, reference is otherwise made to the claims and the drawing.

### LIST OF REFERENCE NUMERALS

1 electric starting device
2 starter motor
2a spur gear
3 crown wheel
4 intermediate shaft
5 spur gear
6 spur gear toothing
7 spur gear toothing
8 spur gear
9 shaft
10 pre-engaged drive/spindle
11 riding pinion
12 toothing
13 ignition rotor
14 angular gearing
15 engine
16 ignition cover
17 crankcase
18 cylinder
19 frame bracing
20 support
21 two-stroke bulb
22 outer surface
23 studs
24 studs
25 cover
26 cover

1. An electric starting apparatus for an internal combustion engine including a starter motor (2) which, via an angular gearing (14) and an interposed pre-engaged drive (10), is engageable with a toothing (12) on an ignition rotor (13) for driving a crankshaft of the internal combustion engine (15) and wherein a motor shaft of the starter motor (2) is arranged substantially at a right angle to the longitudinal centerline of the crankshaft, characterized in that the angular gearing (14) comprises a crown wheel (3) and a spur gear (5) non-rotatably arranged on an intermediate shaft (4), and wherein the spur gear (5) is meshable with a spur gear (8) of the pre-engaged drive (10).

2. The electric starting apparatus as set forth in claim 1, characterized in that arranged at the motor shaft of the starter motor is a spur gear (2a) meshing with the crown wheel (3), such that a longitudinal centerline of the motor shaft is oriented in the direction of a spur gear toothing (6) of the spur gear (5) of the angular gearing (14), such that wherein the longitudinal centerline and the spur gear toothing (6) are arranged on one side of a longitudinal centerplane of the crown wheel (3).

3. The electric starting apparatus set forth in claim 1, characterized in that the internal combustion engine is an engine (15) of a two-wheeled vehicle.

4. The electric starting apparatus as set forth in claim 1, characterized in that the angular gearing (14) and the pre-engaged drive (10) are disposed between a crankcase (17) and a cover (16) concealing the ignition rotor (13) and definable at the crankcase (17).

5. The electric starting apparatus as set forth in claim 4, characterized in that the starter motor (2) is arranged outside of the cover (16) and mounted, by a support, at a frame component of the two-wheeled vehicle.

6. The electric starting apparatus set forth in claim 5, wherein the starter motor (2), as viewed in the forwards direction of the vehicle, it is arranged aft of an exhaust means (21) and at an outer surface (22) of a fuel tank of the two-wheeled vehicle.

7. The electric starting apparatus as set forth in claim 1, characterized in that a longitudinal centerline of a shaft of the pre-engaged drive (10) is oriented practically parallel to the longitudinal centerline of the crankshaft.

8. The electric starting apparatus as set forth in claim 4, characterized in that the pre-engaged drive (10) and the angular gearing (14) are mounted in dry-running bushes in the crankcase (17), and in the cover (16), and in a cover (26) concealing the crown wheel (3).

9. A two-stroke internal combustion engine (15) comprising an electric starting apparatus as set forth in claim 1.

10. A vehicle having a frame and at least one front wheel and a rear wheel, characterized by a two-stroke internal combustion engine (15) as set forth in claim 9.

11. An electric starting apparatus for an internal combustion engine having a starter motor which is engageable with a toothing on an ignition rotor for driving a crankshaft, said engagement via an angular gearing and an interposed pre-engaged drive, wherein:
a motor shaft of the starter motor is disposed substantially perpendicularly to the longitudinal centerline of the crankshaft;
the angular gearing comprises a crown wheel and a first spur gear non-rotatably disposed on an intermediate shaft;
the spur gear is meshable with a second spur gear upon the pre-engaged drive; and
a third spur gear, disposed at the motor shaft of the starter motor, meshing with the crown wheel.

12. The electric starting apparatus as set forth in claim 11, wherein a longitudinal centerline of the motor shaft is oriented in the direction of a spur gear toothing of the first spur gear; and
wherein the longitudinal centerline and the spur gear toothing are disposed on a side of a longitudinal centerplane of the crown wheel.

13. The electric starting apparatus as set forth in claim 12 further comprising:
a crankcase; and
a cover concealing the ignition rotor and definable at the crankcase;
wherein the angular gearing and the pre-engaged drive are disposed between the crankcase and cover.

14. The electric starting apparatus as set forth in claim 13 wherein the starter motor is arranged outside of the cover and is disposed at a frame component of a two-wheeled vehicle by means of a support.

15. The electric starting apparatus set forth in claim 14 wherein the starter motor, as viewed in the forwards direction of the two-wheeled vehicle, is arranged aft of an exhaust means and adjacent an outer surface of a fuel tank of the two-wheeled vehicle.

16. The electric starting apparatus as set forth in claim 15 wherein a longitudinal centerline of a shaft of the pre-engaged drive is oriented substantially parallel to the longitudinal centerline of the crankshaft.

17. The electric starting apparatus as set forth in claim 16 wherein the pre-engaged drive and the angular gearing are mounted in dry-running bushes in the crankcase, in the cover, and in a cover concealing the crown wheel.
